(19) United States
(12) Patent Application Publication
(10) Pub. No.: US 2016/0056559 A1
(43) Pub. Date: Feb. 25, 2016

(54) PRINTED BOARD CONNECTING STRUCTURE

(71) Applicant: Azbil Corporation, Tokyo (JP)

(72) Inventors: Yukio IWABUCHI, Tokyo (JP); Ken IWAKIRI, Tokyo (JP); Yoshiyuki MATSUMURA, Tokyo (JP); Kazutaka MURAKAMI, Tokyo (JP)

(73) Assignee: Azbil Corporation, Tokyo (JP)

(21) Appl. No.: 14/819,858

(22) Filed: Aug. 6, 2015

(30) Foreign Application Priority Data
Aug. 25, 2014 (JP) 2014-170140

(51) Int. Cl. H01R 12/71; H01R 12/70

(52) U.S. Cl. CPC H01R 12/71; H01R 12/7005

(57) ABSTRACT

A printed board connecting structure including a first printed board provided with either a male or female connector as a first connector, and a second printed board provided with the other connector (the female or male connector) as a second connector, wherein the first printed board and the second printed board are connected through mating of the first connector and the second connector. The first printed board comprises a guiding hole on a board surface in the vicinity of the first connector; and the second printed board comprises a guiding protrusion for guiding the mating of the first connector and the second connector by first engaging with the guiding hole of the first printed board when the first connector and the second connector are to be mated.

### CROSS-REFERENCE TO RELATED APPLICATIONS

This application claims priority under 35 U.S.C. §119 to Japanese Patent Application No. 2014-170140, filed on Aug. 25, 2014, the entire content of which being hereby incorporated herein by reference.

### FIELD OF TECHNOLOGY

The present invention relates to a printed board connecting structure for connecting printed boards together through mating of a connector.

Conventionally, connections between printed boards have been carried out through mating connectors. That is, printed boards have been connected together through mating together one male/female connector with another. The connectors used for connecting together printed boards have been provided with guiding functions for guiding to a proper mating, along with a function for connecting the signal lines. See, for example, Japanese Unexamined Patent Application Publication 2010-55798. Moreover, there are also connectors that have, for example, sequencing functions (functions for establishing the sequence of contact for, for example, the ground terminal, the power supply terminals, signal terminals, and the like) along with the function for guiding to the connector. See, for example, Japanese Unexamined Patent Application Publication 2004-145676.

However, connectors provided with the guiding function and the sequencing function are expensive. When an inexpensive connector that is not provided with a guiding function is used, there will be the risk that there will be a problem such as the printed boards not being connected together properly, difficulties in inserting the connector, breakage of connectors, and the like, due to misalignment of the insertion, or being inserted backward, due to not having the guiding function. When a connector that has no sequencing function is used, there will be the possibility of damage to the components that are mounted on the board, through static electricity accumulated in the board.

The present invention was created in order to solve problems such as these, and the aspect thereof is to provide a printed board connecting structure wherein there is no risk of a problem such as damage to components, where the insertion of the connection is easy, and wherein the printed boards can be connected together properly, even when using an inexpensive connector that is not provided with a guiding function or a sequencing function.

### SUMMARY

The present invention, in order to achieve the aspect set forth above, is a printed board connecting structure including a first printed board provided with either a male or female connector as a first connector, and a second printed board provided with the other connector (the female or male connector) as a second connector, wherein the first printed board and the second printed board are connected through mating of the first connector and the second connector, wherein: the first printed board comprises a guiding hole on a board surface in the vicinity of the first connector; and the second printed board comprises a guiding protrusion for guiding the mating of the first connector and the second connector by first engaging with the guiding hole of the first printed board when the first connector and the second connector are to be mated.

Given this invention, if, for example, the first printed board is a motherboard and the second printed board is a child board, motherboard and the child board are connected through mating together of a first connector and a second connector. When connecting the motherboard and the child board, in the present invention the child board guiding protrusion engages into the motherboard guiding hole, and the first connector and the second connector are mated together with the engagement of the guiding hole and the guiding protrusion as guidance. Through this, a simple guiding function is added to the printed board, enabling proper connection of printed boards together even when using an inexpensive connector that is not provided with a guiding function, making the insertion of the connector easy, without the risk of problems such as damaged connectors.

In the present invention, the guiding holes provided in the first printed board may be singular or plural. Moreover, the sizes of the guiding holes may be different. For example, if the first printed board is a motherboard and the second printed board is a child board, the position in the motherboard wherein a child board that is provided with general-use functions or a child board that is provided with specialty functions are mountable are defined by the sizes and numbers of guiding holes in the motherboard and the combination of guiding protrusions provided in the child board, thus enabling simple prevention incorrect mounting.

Moreover, in the present invention, conducting patterns that make contact when the guiding hole and the guiding protrusion are engaged may be formed on the guiding hole of the first printed board and the guiding protrusion of the second printed board. When this is done, when connecting the first printed board and the second printed board, the conducting pattern that is formed on the guiding hole and the guiding protrusion are caused to make contact prior to the mating of the first connector and the second connector, causing the static electricity accumulated in the second printed board to be discharged through the connector, thereby reducing the risk of damaged components when the printed board is inserted.

Given the present invention, a guiding hole is provided in the surface of the board in the vicinity of a first connector of a first printed board, and a guiding protrusion is provided on a second printed board, so that when mating the first connector and the second connector, the guiding protrusion of the second printed board first engages the guiding hole of the first printed board, to guide the mating of the first connector and the second connector, and thus a simple guiding function is added to the printed boards, making it possible to connect to the printed boards together properly even when using inexpensive connectors that are not provided with guiding functions, enabling the connectors to be inserted easily, and eliminating the risk of problems such as damaged connectors. Moreover, conducting patterns that make contact at the time of engaging of the guiding hole and the guiding protrusion are formed on the guiding hole of the first printed board and the guiding protrusion of the second printed board, making it possible to reduce the risk of damage to components when the printed board is inserted.

### BRIEF DESCRIPTION OF THE DRAWINGS

FIG. 1 is a diagram illustrating the critical components of an Example of a printed board connecting structure according to the present invention.

FIG. 2(a) is a plan view and 2(b) is a side view of a motherboard in the Example.

FIG. 3(a) is a plan view and 3(b) is a side view of a child board in the Example.

FIG. 4 is a diagram illustrating the state wherein the motherboard and child board in the Example are being connected, with the mating of the guiding hole and guiding protrusion as guidance.

FIG. 5 is a diagram illustrating the critical components of Another Example of a printed board connecting structure according to the present invention.

FIG. 6(a) is a plan view and 6(b) is a side view of a motherboard in the Another Example.

FIG. 7(a) is a plan view and 7(b) is a side view of a first child board in the Another Example.

FIG. 8(a) is a plan view and 8(b) is a side view of a second child board in the Another Example.

FIG. 9 is a diagram illustrating the state wherein the motherboard and first child board and second child board in the Another Example are being connected, with the mating of the guiding hole and guiding protrusion as guidance.

FIG. 10 is a diagram for explaining the mountability of the first child board in the Another Example onto a first child board mounting portion and also onto a second child board mounting portion.

FIG. 11 is a diagram illustrating the critical components of a Yet Another Example of a printed board connecting structure according to the present invention.

FIG. 12 is a diagram illustrating a plan view of the motherboard in the Yet Another Example and an enlargement of the vicinity of the guiding hole in the motherboard.

FIG. 13(a) is a plan view and 13(b) is a side view of a child board in the Yet Another Example.

FIG. 14 is a diagram illustrating the state wherein the motherboard and child board in the Yet Another Example being connected, with the mating of the guiding hole and guiding protrusion as guidance.

### DETAILED DESCRIPTION

An example according to the present disclosure will be explained below in detail, based on the drawings.

### Example

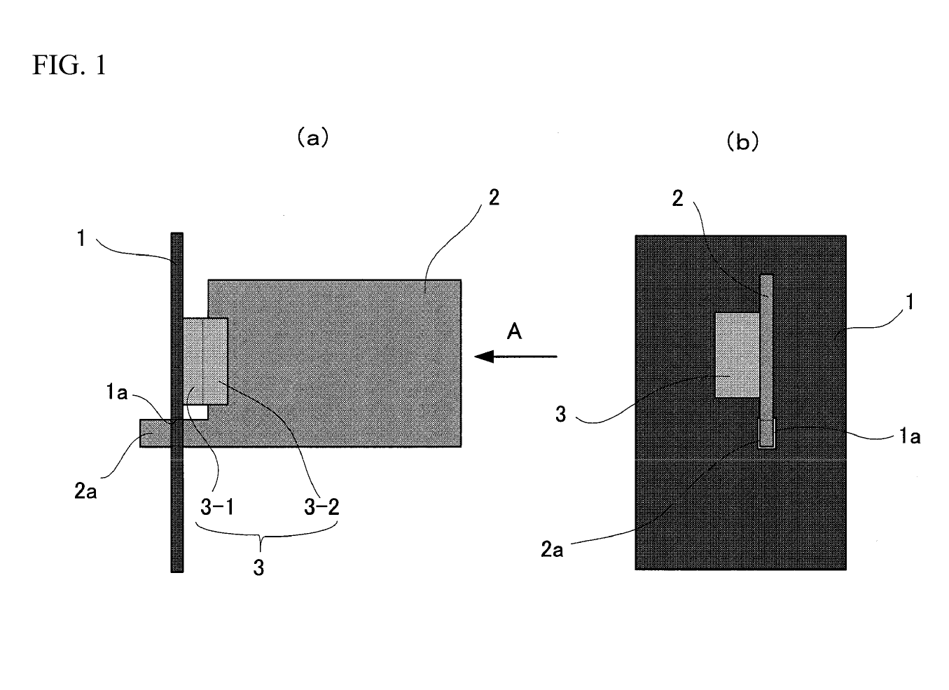

FIG. 1 is a diagram illustrating the critical components of an Example of a printed board connecting structure according to the present invention, wherein FIG. 1 (a) is a side view and FIG. 1 (b) is a diagram when FIG. 1 (a) is viewed in the direction of arrow A.

In FIG. 1, 1 is a first printed board (a motherboard), 2 is a second printed board (a child board), and 3 is a connector (a male/female connector) for connecting the motherboard 1 and the child board 2, where an inexpensive connector that is not provided with a guiding function is used for the connector 3.

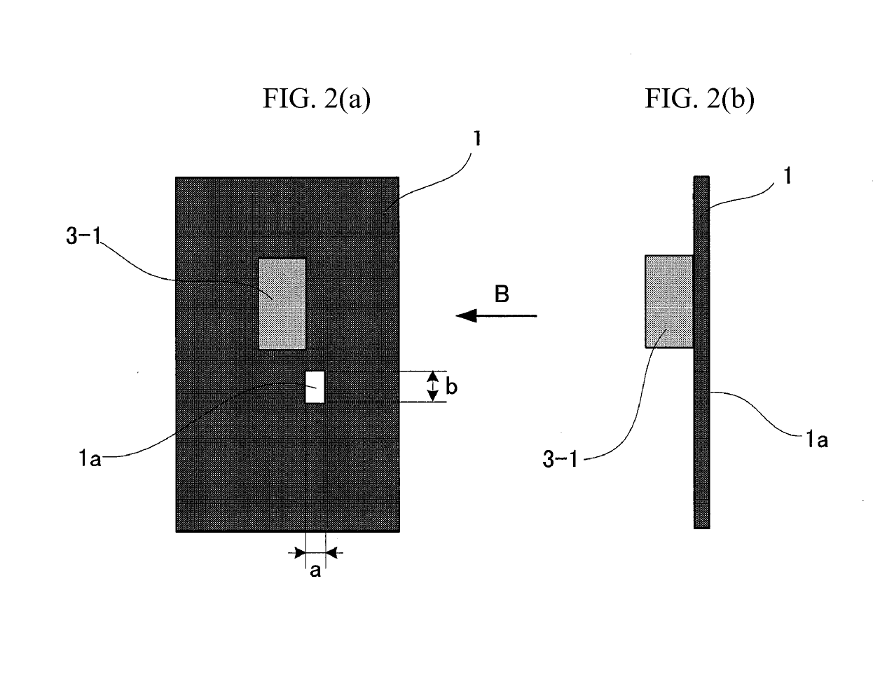

As is illustrated in the plan view in FIG. 2 (a) and in the side view in FIG. 2 (b) (a diagram wherein FIG. 2 (a) is viewed in the direction of the arrow B), in the motherboard 1 one side of a male/female connector 3 is mounted as a first connector 3-1, where a guiding hole 1a is formed in the board surface in the vicinity of the first connector 3-1.

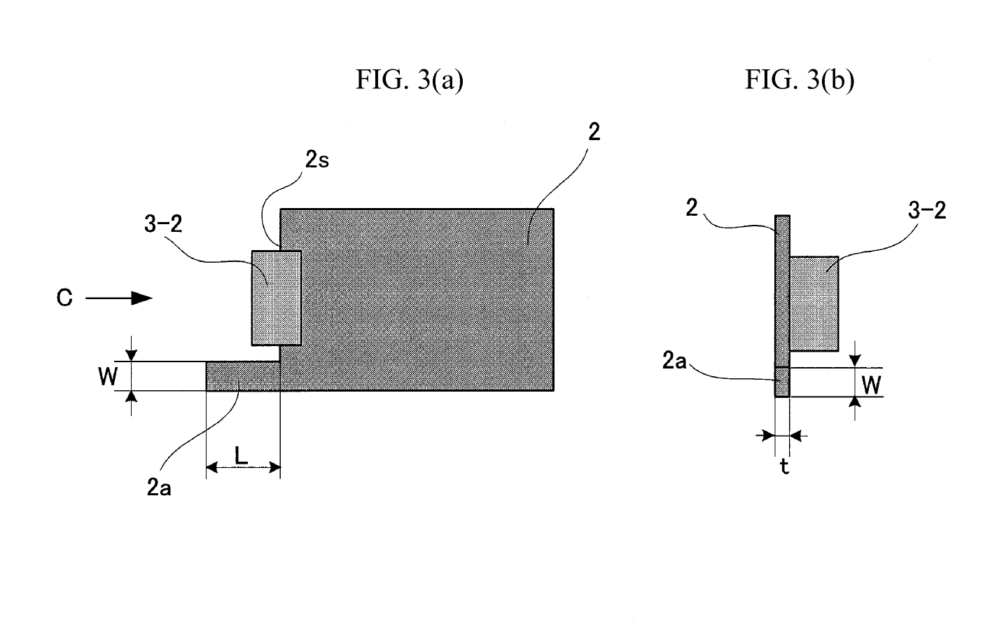

Moreover, as is shown in the plan view in FIG. 3 (a) and in the side view in FIG. 3 (b) (which is a diagram wherein FIG. 3 (a) is viewed from the direction of the arrow C), in the child board 2 the other male/female connector 3 is mounted as the second connector 3-2, where a guiding protrusion 2a is formed integrally in the downward direction of the edge surface 2s on the side of the child board 2 wherein the second connector 3-2 is mounted.

In the child board 2, for the guiding protrusion 2a, the length from the edge surface 2s of the child board 2 is L, and the width is W. The thickness t of this guiding protrusion 2a is equal to the thickness of the child board 2.

In the motherboard 1, the guiding hole 1a is formed in a position that matches that of the guiding protrusion 2a that is formed in the child board 2 when the first connector 3-1 of the motherboard 1 is mated correctly with the second connector 3-2 of the child board 2.

The shape of the guiding hole 1a is rectangular, matching the cross-sectional shape of the guiding protrusion 2a, having a crosswise direction length a that is slightly greater than the thickness t of the protrusion 2a, and having a length b in the lengthwise direction that is slightly larger than the width W of the protrusion 2a.

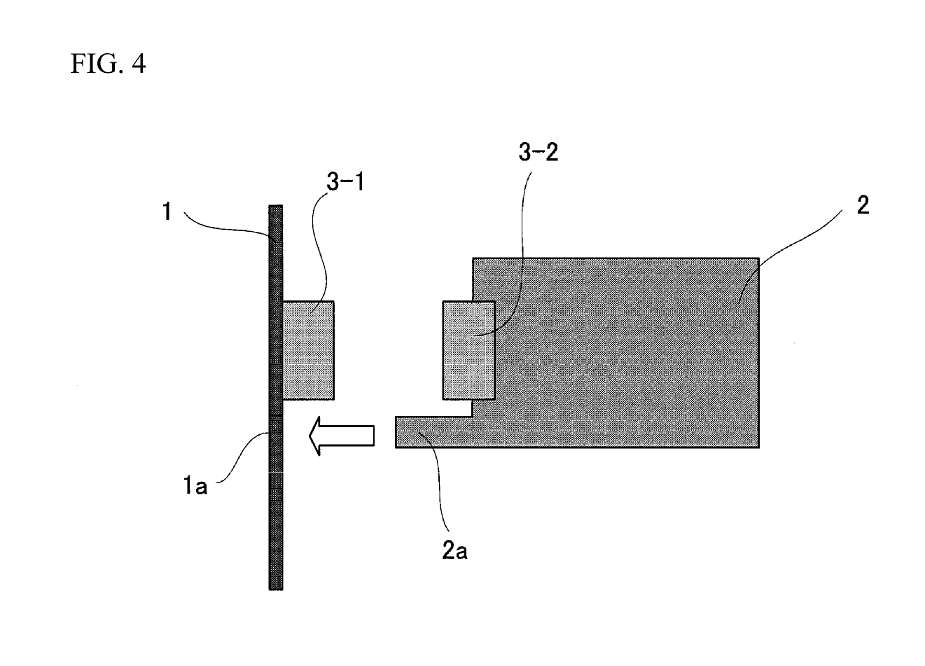

In the printed board connecting structure in this Example, the motherboard 1 and the child board 2 are connected through mating the first connector 3-1 and the second connector 3-2. When connecting the motherboard 1 and the child board 2, first the guiding protrusion 2a of the child board 2 is inserted into (engaged with) the guiding hole 1a of the motherboard 1 (referencing FIG. 4). Following this, the first connector 3-1 and the second connector 3-2 are mated, with the engagement of the guiding hole 1a and the guiding protrusion 2a as guidance.

As can be appreciated from the explanation above, in the printed board connecting structure according to the Example, when connecting the motherboard 1 and the child board 2, the mating of the first connector 3-1 and the second connector 3-2 is carried out with the engagement of the guiding hole 1a of the motherboard 1 and the guiding protrusion 2a of the child board 2 as guidance, and thus even if connectors that do not have guiding functions are used as the connectors 3 (3-1 and 3-2), still there will be no misalignment of the insertion position of the connector 3 nor reversed insertion, making it possible to connect the motherboard 1 and the child board 2 properly, enabling the connector 3 to be inserted easily, and preventing problems such as damage to the connector 3.

### Another Example

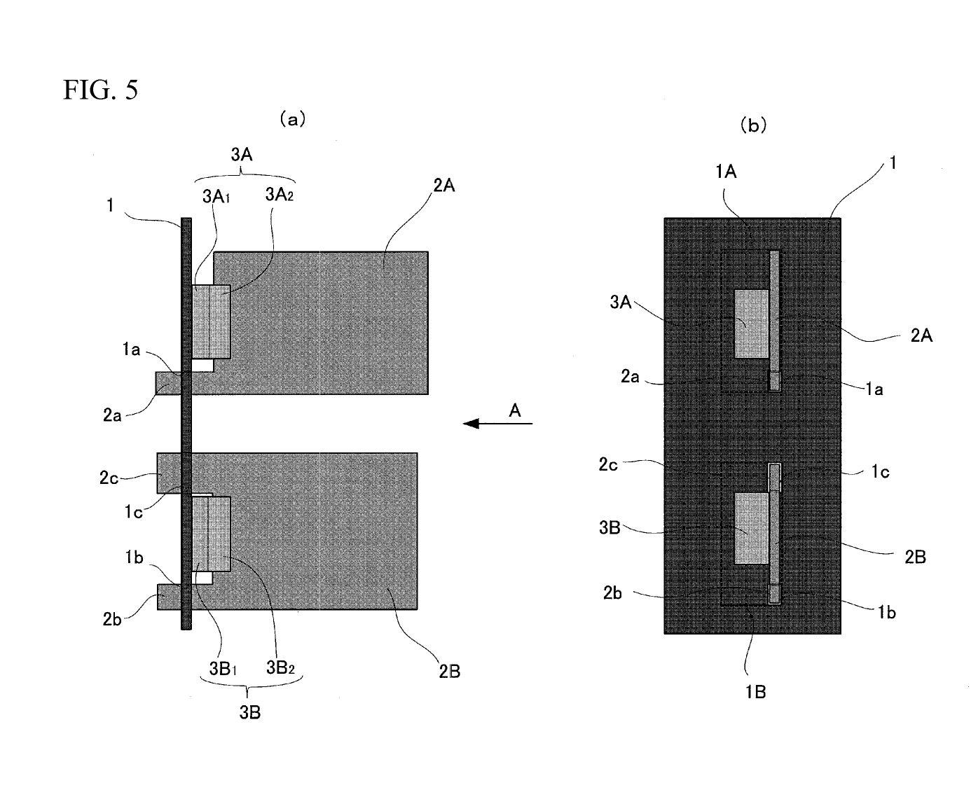

FIG. 5 is a diagram illustrating the critical components of Another Example of a printed board connecting structure according to the present invention, wherein FIG. 5 (a) is a side view and FIG. 5 (b) is a diagram when FIG. 5 (a) is viewed in the direction of arrow A.

In FIG. 5, 1 is a first printed board (a motherboard), 2A and 2B are second printed boards (child boards), and 3A and 3B connectors (male/female connectors) for connecting the motherboard 1 and the child boards 2A and 2B, where inexpensive connectors of the same type, not provided with a guiding function, are used for the connectors 3A and 3B.

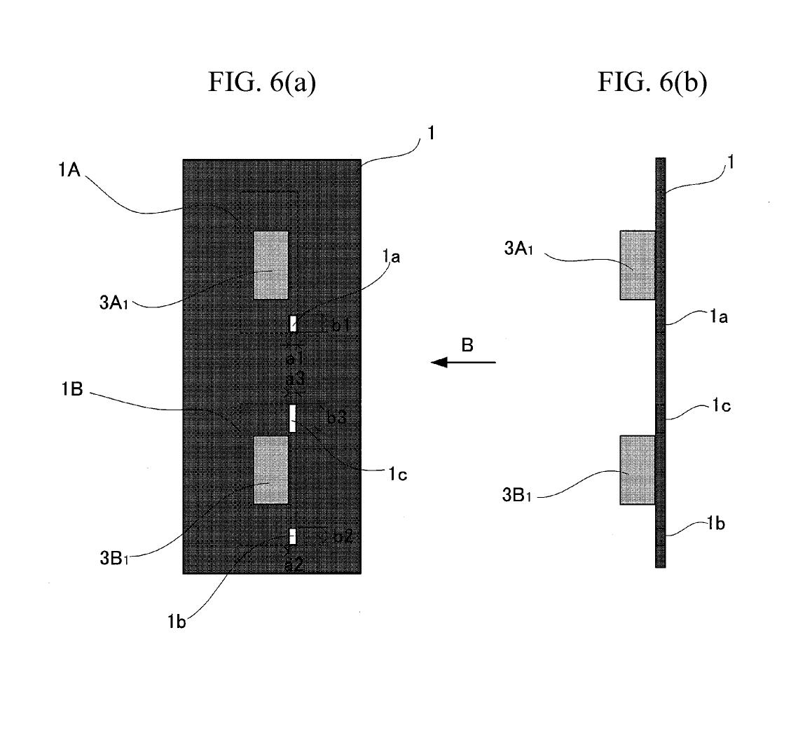

As is illustrated in the plan view in FIG. 6 (a) and in the side view in FIG. 6 (b) (a diagram wherein FIG. 6 (a) is viewed in the direction of the arrow B), a first child board mounting portion 1A and a second child board mounting portion 1B are provided in the motherboard 1.

In the motherboard 1, one male/female connector 3A is mounted, as a first connector 3A1, at the first child board mounting portion 1A, and a guiding hole 1a is formed in the surface of the board around this first connector 3A1.

In the motherboard 1, one male/female connector 3B is mounted, as a first connector 3B1, at the second child board mounting portion 1B, and guiding holes 1b and 1c is formed in the surface of the board around this first connector 3B1.

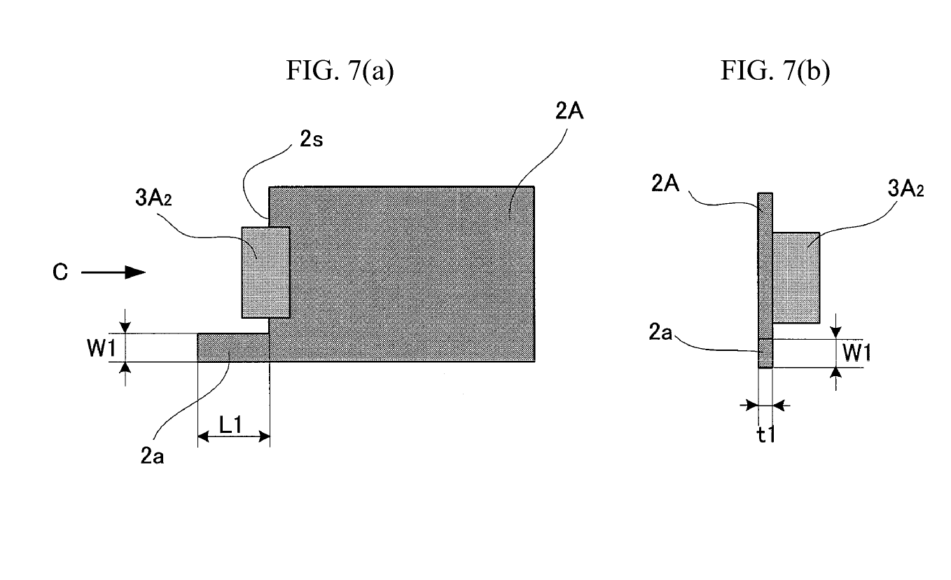

Moreover, as is shown in the plan view in FIG. 7 (a) and in the side view in FIG. 7 (b) (which is a diagram wherein FIG. 7 (a) is viewed from the direction of the arrow C), in the first child board 2A the other male/female connector 3A is mounted as the second connector 3A2, where a guiding protrusion 2a is formed integrally in the downward direction of the edge surface 2s on the side of the first child board 2A wherein the second connector 3A2 is mounted.

In the first child board 2A, for the guiding protrusion 2a, the length from the edge surface 2s of the first child board 2A is L1, and the width is W1. The thickness t1 of this guiding protrusion 2a is equal to the thickness of the first child board 2A.

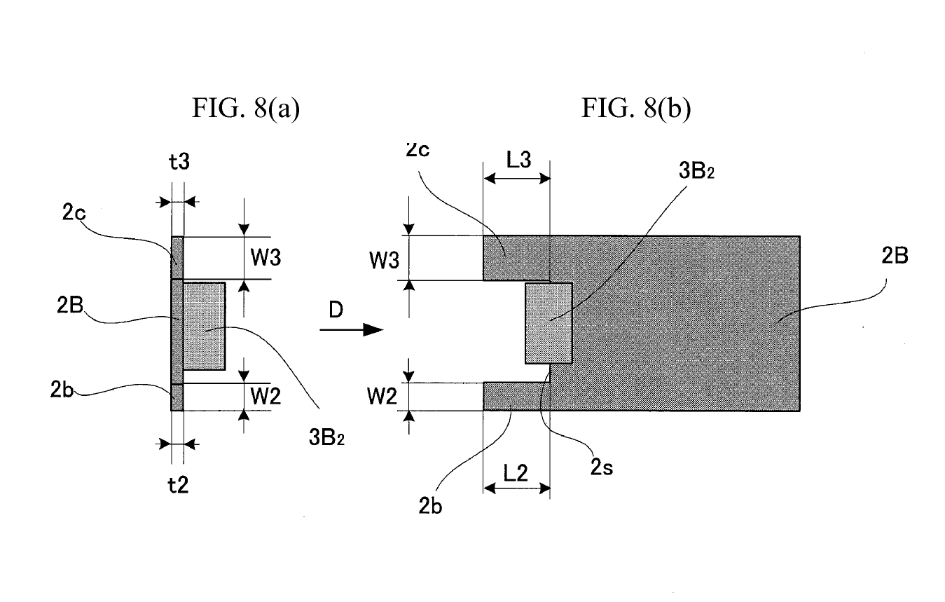

Moreover, as is shown in the plan view in FIG. 8 (a) and in the side view in FIG. 8 (b) (which is a diagram wherein FIG. 8 (a) is viewed from the direction of the arrow D), in the second child board 2B the other male/female connector 3B is mounted as the second connector 3B2 on the second board 2B, where guiding protrusion 2b and 2c are formed integrally in the downward direction of the edge surface 2s on the side of the first child board 3B wherein the second connector 3B2 is mounted.

In the second child board 2B, for the guiding protrusion 2b, the length from the edge surface 2s of the second child board 2B is L2, and the width is W2. Moreover, for the guiding protrusion 2c, the length from the edge surface 2s of the second child board 2B is L3, and the width is W3. In these guide protrusions 2b and 2c, the widths W2 and W3 are such that W3>W2. The thicknesses t2 and t3 of these guiding protrusions 2b and 2c are equal to the thickness of the second child board 2B.

The guiding hole 1a in the first child board mounting portion 1A of the motherboard 1 is formed in a position that matches that of the guiding protrusion 2a that is formed in the first child board 2A when the first connector 3A1 that is mounted on the first child board mounting portion 1A and the second connector 3A2 of the first child board 2A are mated.

The shape of the guiding hole 1a is rectangular, matching the cross-sectional shape of the guiding protrusion 2a, having a crosswise direction length a1 that is slightly greater than the thickness t1 of the protrusion 2a, and having a length b1 in the lengthwise direction that is slightly larger than the width W1 of the protrusion 2a.

The guiding holes 1b and 1c in the second child board mounting portion 1B of the motherboard 1 are formed at positions that match those of the guiding protrusions 2b and 2c that are formed in the second child board 2B when the first connector 3B1 that is mounted on the second child board mounting portion 1B and the second connector 3B2 of the second child board 2B are mated.

The shapes of the guiding hole 1b and 1c are rectangular, matching the cross-sectional shapes of the guiding protrusions 2b and 2c, where a crosswise direction length a2 of the guiding hole 1b is slightly greater than the thickness t2 of the protrusion 2b, the length b2 in the lengthwise direction of the guiding hole 1b is slightly larger than the width W2 of the protrusion 2b. Moreover, the crosswise direction length a3 of the guiding hole 1c is slightly greater than the thickness t3 of the protrusion 2c, and the length b3 in the lengthwise direction the guiding hole 1c is slightly larger than the width W3 of the protrusion 2c.

Moreover, the first child board 2A and the second child board 2B have identical thicknesses, where the protrusion 2a in the first child board 2A and the protrusion 2b in the second child board 2B are provided at identical positions, where the length L1 and L2 thereof and the widths W1 and W2 thereof are also identical. That is, in the first child board 2A and the second child board 2B, the board shapes on the side wherein the connector is mounted are identical, except for the protrusion 2c. Moreover, the first child board 2A is provided with a general-use function, and the second child board 2B is provided with a specialty function.

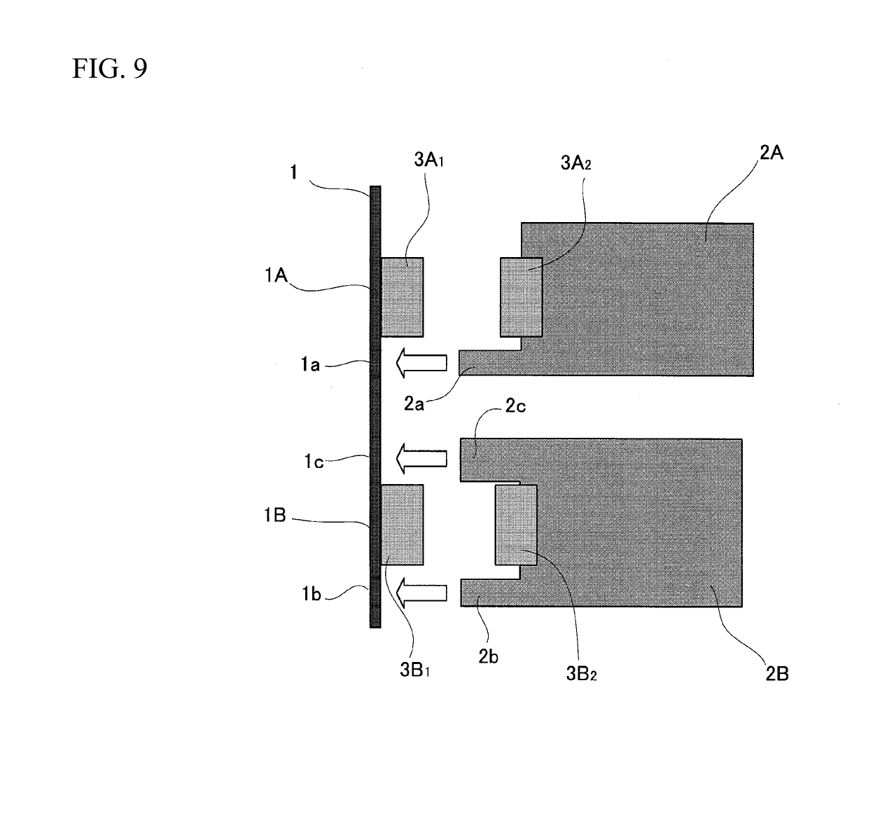

In the printed board connecting structure of the Another Example, the motherboard 1 and the first child board 2A are connected through mating the first connector 3A1 and the second connector 3A2. When connecting the motherboard 1 and the first child board 2A, first the guiding protrusion 2a of the first child board 2A is inserted into (engaged with) the guiding hole 1a in the first child board mounting portion 1A of the motherboard 1 (referencing FIG. 9). Following this, the first connector 3A1 and the second connector 3A2 are mated, with the engagement of the guiding hole 1a and the guiding protrusion 2a as guidance.

Moreover, in the printed board connecting structure of the Another Example, the motherboard 1 and the second child board 2B are connected through mating the first connector 3B1 and the second connector 3B2. When connecting the motherboard 1 and the second child board 2B, first the guiding protrusion 2b and 2c of the second child board 2B are inserted into (engaged with) the guiding holes 1b and 1 c in the second child board mounting portion 1B of the motherboard 1 (referencing FIG. 9). Following this, the first connector 3B1 and the second connector 3B2 are mated, with the engagement of the guiding holes 1b and 1c and the guiding protrusions 2b and 2c as guidance.

As can be understood from the explanation above, in the printed board connecting structure according to the present example, when the motherboard 1 and the first child board 2A are connected, the engagement of the first connector 3A1 and the second connector 3A2 is carried out through the guidance of the engagement of the guiding hole 1a and the guiding protrusion 2a of the first child board 2A in the first child board mounting portion 1A of the motherboard 1, and when connecting the motherboard 1 and the second child board 2B, the mating of the first connector 3B1 and the second connector 3B2 is carried out through the guidance of the guiding holes 1b and 1c and the guiding protrusions 2b and 2c of the second child board 2B in the second child board mounting portion 1B of the motherboard 1, thus making it possible to connect the motherboard 1 and the child boards 2A and 2B without misalignment of the insertion positions of the connectors 3A and 3B, and without the occurrence of incorrect insertion (backwards insertion), even when using, as the connectors 3A (3A1 and 3A2) and 3B (3B1 and 3B2), inexpensive connectors that are not provided with guiding functions, making insertion of the connectors 3A and 3B easy, and eliminating problems with, for example, damaged connectors 3A and 3B.

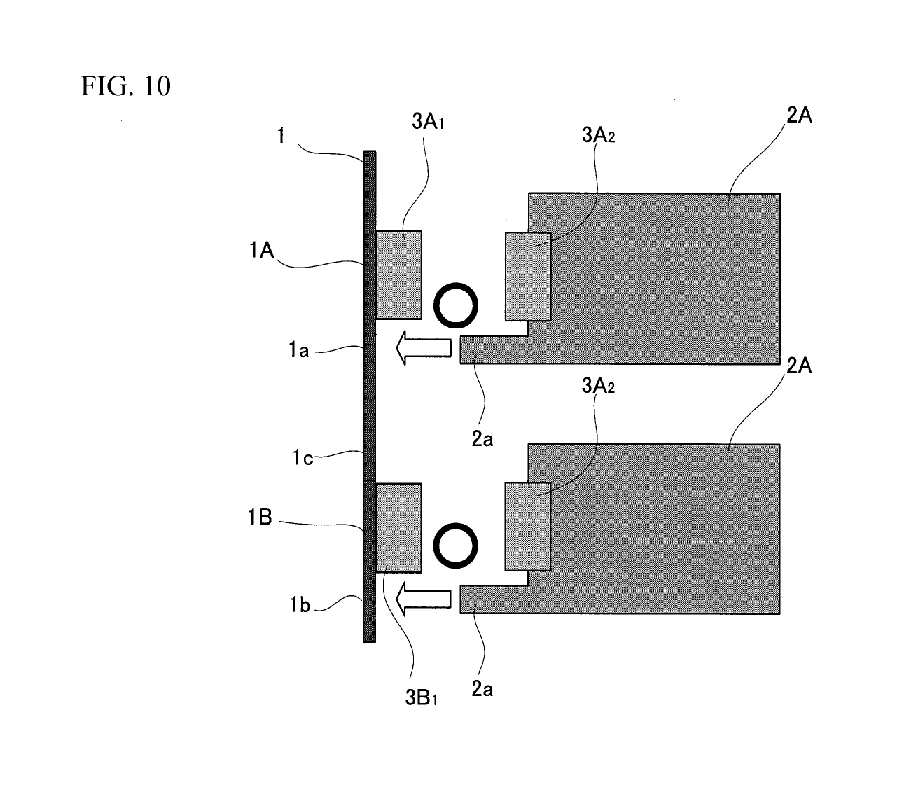

Moreover, in the printed board connecting structure according to the Another Example, the first child board 2A that is provided with the general-use function is provided with only the guiding protrusion 2a, where this guiding protrusion 2a is of the same shape as the guiding protrusion 2b of the second child board 2B, and thus, as illustrated in FIG. 10, it is mountable in both the first child board mounting portion 1A and in the second child board mounting portion 1B. In contrast, the second child board 2B, which is provided with the specialty function, is provided with the guiding protrusion 2b and the guiding protrusion 2c, and thus is mountable in only the second child board mounting portion 1B.

In the printed board connecting structure of the Another Example, the sizes or numbers of the guiding holes provided in the motherboard 1 are varied to define the positions wherein a child board 2 (2A) that is provided with a general-use function and a child board 2 (2B) that is provided with a specialty function can be mounted on the motherboard 1, through the combination with the guiding protrusions provided in the child board 2, to thereby prevent erroneous mounting simply.

### Yet Another Example

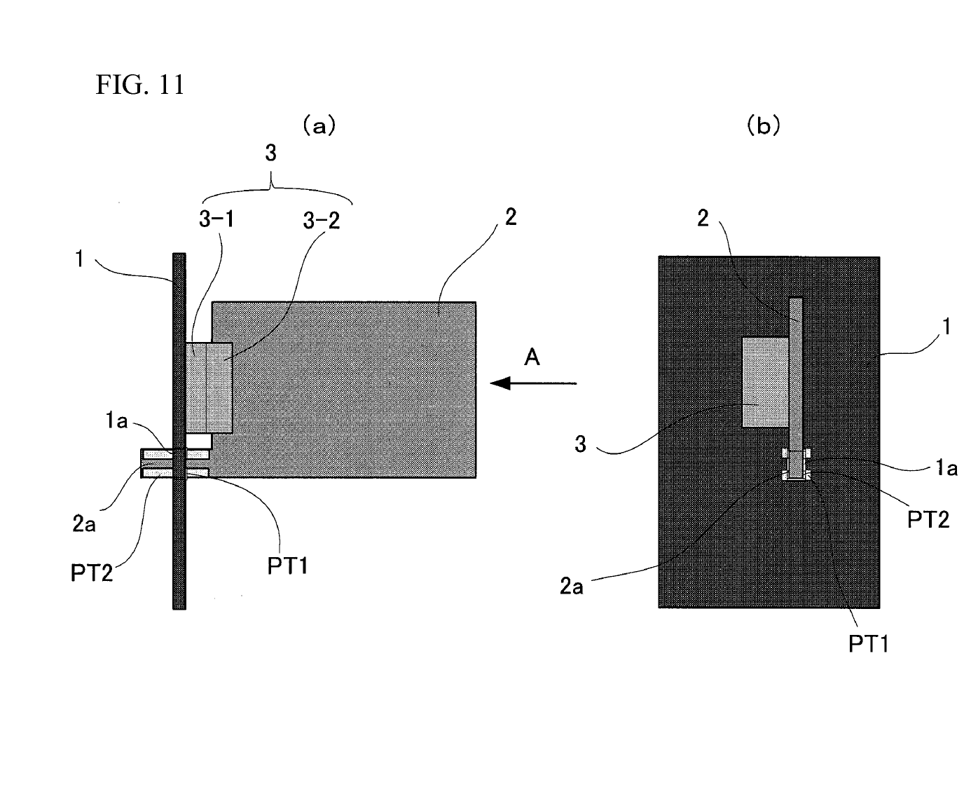

FIG. 11 is a diagram illustrating the critical components of a Yet Another Example of a printed board connecting structure according to the present invention, wherein FIG. 11 (a) is a side view and FIG. 11 (b) is a diagram when FIG. 11 (a) is viewed in the direction of arrow A.

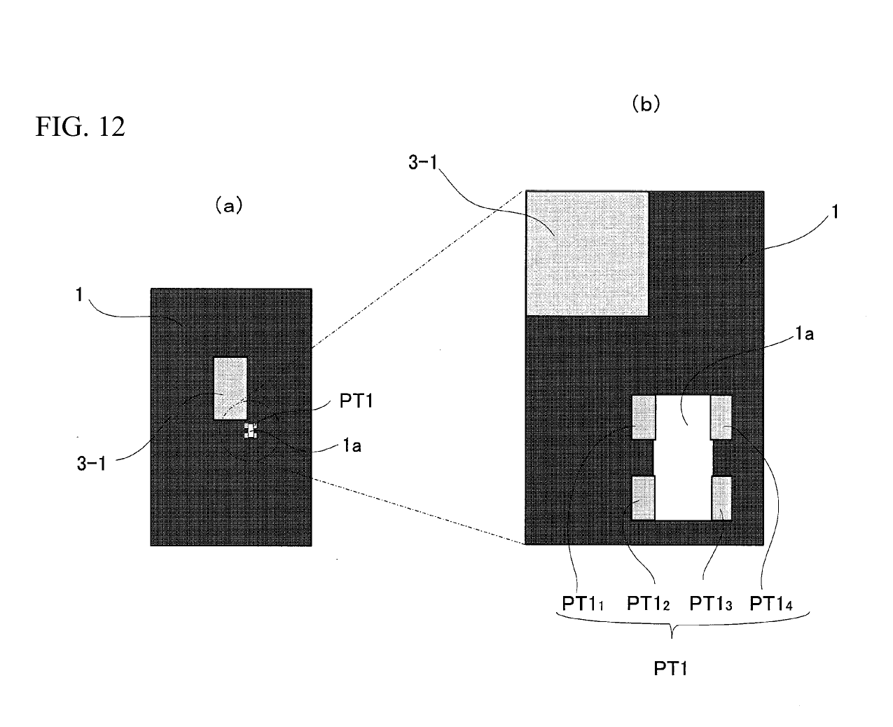

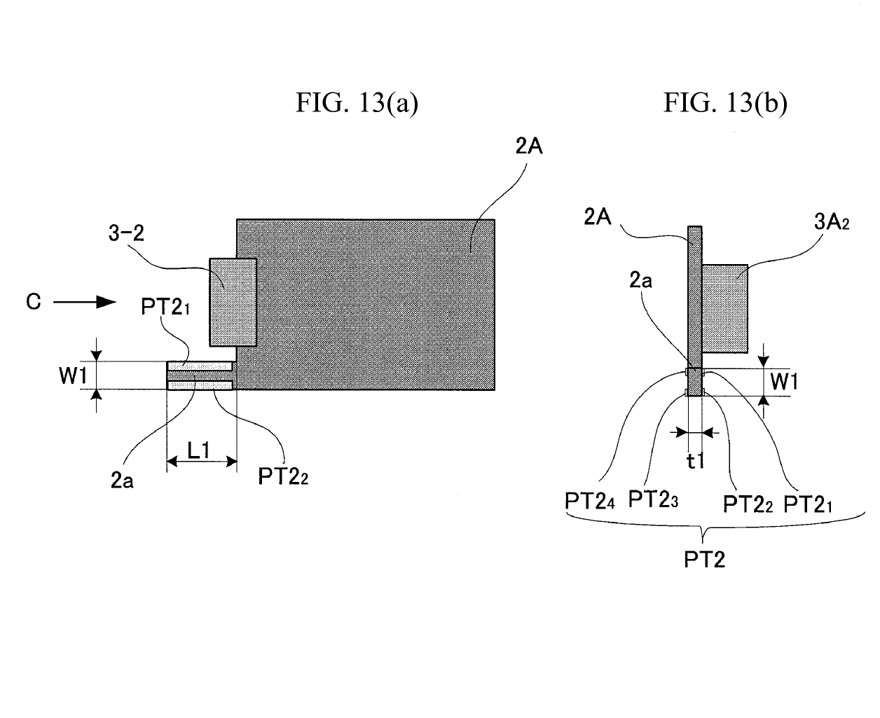

In the printed board connecting structure according to the Yet Another Example, conducting patterns PT1 (PT11 through PT14) are formed on the peripheries of the guiding holes 1a in the motherboard 1, in the printed board connecting structure of the Example (FIG. 1) (referencing FIG. 12). Moreover, conducting patterns PT2 (PT21 through PT24) are formed on the peripheries of the guiding protrusions 2a of the child board 2 (referencing FIG. 13).

Note that FIG. 12 (a) is a plan view of the motherboard 1 and FIG. 12 (b) is an enlargement in the vicinity of the guiding hole 1a of the motherboard 1. The conducting patterns PT11 through PT14 are formed so as to extend to the top edge surface from the inner wall surface of the hole 1a, at four locations on the periphery of the guiding holes 1a, to connect to the ground terminal (GND) in the motherboard 1.

Moreover, FIG. 13 (a) is a plan view of a child board 2, and FIG. 13 (b) is a side view of the child board 2 (a diagram when FIG. 13 (b) is viewed from the direction of the arrow C). The conducting patterns PT21 through PT24 are provided corresponding to the conducting patterns PT11 through PT14 that are provided at the guiding holes 1a of the motherboard 1, at four locations on the periphery of the guiding protrusion 2a, and, in the child board 2, are connected to the ground terminal (GND).

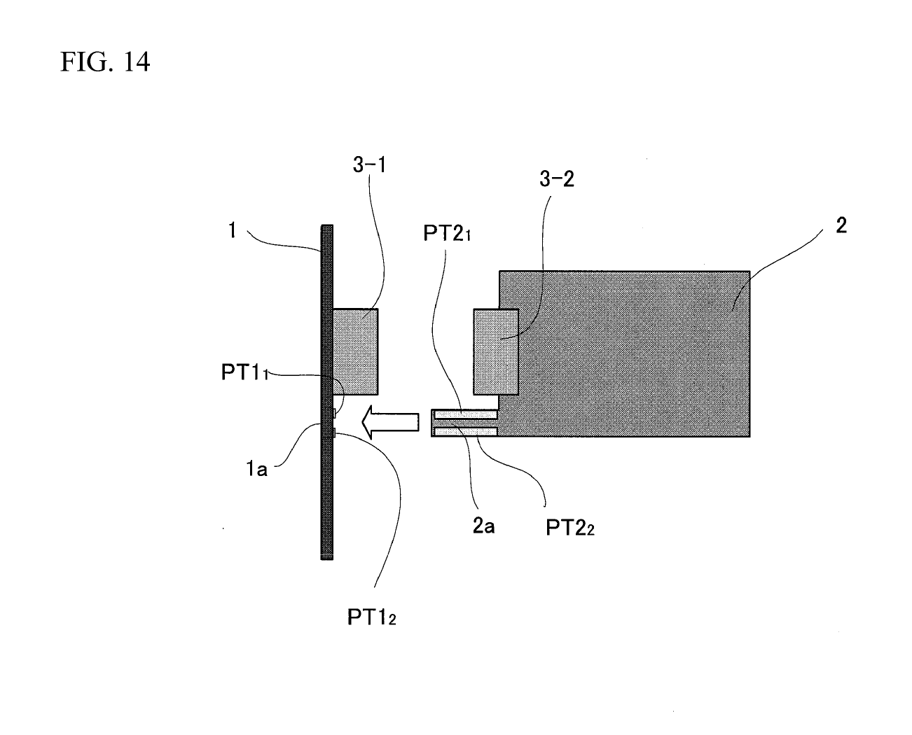

In the printed board connecting structure of this Yet Another Example, when connecting the motherboard 1 and the child board 2 (referencing FIG. 14), the conducting patterns PT1 (PT11 through PT14) that are formed in the guiding holes 1a and the conducting patterns PT2 (PT21 through PT24) that are formed on the guiding protrusions 2a are contacted prior to the mating of the first connector 3-1 and the second connector 3-2.

Through this, the ground terminal of the motherboard 1 and the ground terminal of the child board 2 are connected through the conducting patterns PT1 and PT2 prior to the mating of the connectors 3 (3-1 and 3-2), so the large electric current based on the potential difference that is produced due to static electricity, or the like, between the motherboard 1 and the child board 2 will flow through the conducting patterns PT1 and PT2, thereby preventing damage to the devices that are connected to the signal lines and protecting the plating of the connecting pins.

In this way, in the printed board connecting structure according to the Yet Another Example, a simple sequencing function is added to the printed boards 1 and 2, without adding a sequencing function to the connector 3 (for sequencing the contacting of the ground terminals, power supply terminals, signal terminals, and the like), enabling a reduction in the risk of damage to components of the printed boards 1 and 2 at the time of board insertion.

Note that while in the Yet Another Example the conducting patterns PT1 and PT2 were connected to the ground terminal, that is, were connected to the cold side (GND) of the power supply, they may instead be connected to the hot side (VCC).

### Other Examples

While the present disclosure has been explained above in reference to an example, the present disclosure is not limited to the example set forth above. The structures and details in the present disclosure may be varied in a variety of ways, as can be understood by one skilled in the art, within the scope of technology in the present disclosure.

1: A printed board connecting structure comprising:
a first printed board provided with either a male or female connector as a first connector, and a second printed board provided with the other connector (the female or male connector) as a second connector, wherein the first printed board and the second printed board are connected through mating of the first connector and the second connector, wherein:
the first printed board comprises a guiding hole on a board surface in the vicinity of the first connector; and
the second printed board comprises a guiding protrusion for guiding the mating of the first connector and the second connector by first engaging with the guiding hole of the first printed board when the first connector and the second connector are to be mated.

2: The printed board connecting structure as set forth in claim 1, wherein:
the first printed board comprises a plurality of guiding holes with different sizes, as the guiding hole; and
the second printed board comprises a guiding protrusion for mating with at least one of the plurality of guiding holes of the first printed board.

3: The printed board connecting structure as set forth in claim 1, wherein:
the conducting patterns that make contact when the guiding hole and the guiding protrusion are engaged are formed on the guiding hole and the guiding protrusion.
